(19) United States
(12) Patent Application Publication
(10) Pub. No.: US 2018/0111079 A1
(43) Pub. Date: Apr. 26, 2018

(54) Air Filter with Outlet Receiver and Housing Assembly Incorporating Same

(71) Applicants: Jason LaMarr Tate, Thompsons Station, TN (US); Brian T. Ehrenberg, Kansas City, MO (US); John Michlitsch, Summertown, TN (US); David P. Duryea, Franklin, TN (US); Trenton Yendra, Gibbon, NE (US); Michael J. Von Seggern, Kearney, NE (US)

(72) Inventors: Jason LaMarr Tate, Thompsons Station, TN (US); Brian T. Ehrenberg, Kansas City, MO (US); John Michlitsch, Summertown, TN (US); David P. Duryea, Franklin, TN (US); Trenton Yendra, Gibbon, NE (US); Michael J. Von Seggern, Kearney, NE (US)

(73) Assignee: Baldwin Filters, Inc., Kearney, NE (US)

(21) Appl. No.: 15/723,741

(22) Filed: Oct. 3, 2017

Related U.S. Application Data
(60) Provisional application No. 62/411,934, filed on Oct. 24, 2016.

(51) Int. Cl. B01D 46/52; B01D 46/00

(52) U.S. Cl. CPC B01D 46/523; B01D 46/0098; B01D 46/0005; B01D 2279/60; B01D 2265/02; B01D 2275/20; B01D 2271/022

(57) ABSTRACT

An air filter element fits upon an air cleaner housing with a bar element that is received into the outlet face of the air filter element. The air filter element has a receiver extending into the outlet face to accommodate the bar. In the case of a deep pleated pack for the filter element, a widened split may be provided to accommodate the bar. A protective member that can be provided as part of a basket may project into the outlet face to protect the air filter element pack at the receiver.

### CROSS-REFERENCE TO RELATED PATENT APPLICATIONS

This patent application claims the benefit of U.S. Provisional Patent Application No. 62/411,934, filed Oct. 24, 2016, the entire teachings and disclosure of which are incorporated herein by reference thereto.

### FIELD OF THE INVENTION

The present invention is generally directed toward air filter elements and/or air cleaner assemblies including such air filter elements, and more particularly directed toward engine air filter elements that may be employed in assemblies that have a housing body, a cover and a filter element for filtering fluid flow from an inlet in the cover to an outlet in the housing body, and installations and use of such filter elements therein.

### BACKGROUND OF THE INVENTION

A variety of air panel filters are known, for example, as shown in U.S. Pat. No. 6,824,581 entitled “Pleated Filter Media with Embossed Spacers and Cross Flow”; U.S. Pat. No. 5,820,646 entitled “Inline Filter Apparatus”; and PCT Publication WO 91/19898 entitled “Filter and Process for Manufacturing of Filter.” Improvements over the state of the art are presented herein.

### BRIEF SUMMARY OF THE INVENTION

Embodiments of the present invention are directed toward unique arrangements over the state of the art, which may provide advantages and features not realized in the state of the art.

Embodiments herein may employ traditional panel filters, but in this case, the panel filters can be deep pleated filter elements can be much deeper than traditional panel filters that may often typically have a few inches of pleat depth. While fluted filters employing different sheets may be used in some less preferred embodiments, pleated filter media such as one continuous pleated sheet as opposed to separate sheets is desirable as the requirement of adding or sealing the flutes along inlet faces and outlet faces is not required in such a deep pleat arrangement. For example, filter media packs can be employed according to PCT Application No. PCT/US2016/047283, filed Aug. 17, 2016, entitled “Filter Media Packs, Methods of Making Filter Media Presses” (claiming priority to U.S. Provisional Application Nos. 62/206,100 and 62/243,740), the entire disclosures of which are hereby incorporated by reference in their entireties as the filter media pack examples disclosed therein in various different embodiments thereof may be used and are preferably used in the filter media packs employed in the various embodiments of the present disclosure. However, other non-embossed pleated filter packs may also be employed in less preferred embodiments herein.

According to an embodiment, a filter may include one or more receivers (preferably a saddle shaped receiver) in an outlet face of the filter media pack that can accommodate a receiving bar in the filter housing upon installation.

In a more specific embodiment, the receiver in one embodiment may take the form of a split forming a widened gap between select pleats in a pleated filter media pack embodiment.

According to a more specific embodiment, a protective member extends into the filter media pack and covers the receiver, with the protective member arranged to contact the bar to prevent or limit contact between the bar (of an air cleaner housing) when in use and the filter media pack.

According to another embodiment, a perforated basket is provided that acts as a shroud to protect the filter media.

According to an embodiment, an air filter element is provided. The air filter element comprises a filter media pack defining an inlet face and an outlet face with the filter media pack including filter media extending between the inlet face and the outlet face. A housing seal extends around a periphery of the filter media pack to form a quadrilateral shape, with the housing seal being positioned proximate the inlet face and distal from the outlet face. A receiver is defined into the filter media pack and extends into the outlet face.

According to a more specific embodiment, the filter media pack has a quadrilateral shape with a pair of short sides and a pair of long sides, the long sides being longer than the short sides, with the receiver extending longitudinally transversely between the short sides.

Such as for preferred engine air filter applications, in an more specific embodiment, the filter media pack can have: a width across the inlet face of between 5 and 75 centimeters; a length across the inlet face that is perpendicular to the width of between 10 and 75 centimeters; and a depth perpendicular to the width and the length, the depth being between 10 and 40 centimeters.

Such as for preferred engine air filter applications, in a more specific embodiment, the filter media pack can comprise a filter media sheet that is gathered to provide a plurality of layers (either a pleated construction or a fluted construction), including a spacing of at least 2 layers of the filter media sheet per centimeter as measured across the inlet face and the outlet face, wherein the receiver comprises a gap at the outlet face between adjacent members of the layers defining opposite sides of the gap that is larger than the spacing.

According to a more specific embodiment, the filter media sheet comprises a single continuous uninterrupted sheet extending over and bridging across the gap.

According to a more specific embodiment related to a pleated construction, the filter media pack can comprise a pleat pack including a filter media sheet that includes a plurality of folds that form a plurality of pleats with pleat panels extending between inlet pleat tips along the inlet face and outlet pleat tips along the outlet face. The pleat tips and the pleat panels extend between opposed side edges of the pleated filter media pack, with at least 3 pleat panels per centimeter across inlet face and the outlet face being provided.

In such an embodiment, for example, the pleats can include a pleat spacing of at least 0.75 pleats per centimeter with 1.5 pleat panels per centimeter as measured across the inlet face and the outlet face, with the receiver comprising a gap at the outlet face between adjacent members of the pleat panels that spaces the pleat panels more than the pleat spacing.

According to a more specific embodiment related to a pleated construction, the filter media sheet can comprise a single continuous uninterrupted sheet extending over and bridging across the gap, with the gap comprises a split wedge formed the pleat pack between the adjacent members of the pleat panels defining opposite sides of the gap.

According to a more specific embodiment, the air filter element may further comprise a perforated basket including a peripheral wall, an outlet wall and a divider portion. The peripheral wall protects the filter media pack around the periphery, with the outlet wall covering and protecting the filter media pack over the outlet face, and the divider portion extending into the outlet face and defining first and second portions on opposing sides of the receiver and providing a protective barrier along the receiver facing the outlet face.

According to a more specific embodiment, an air filter element may comprise a border frame sealingly connected to the filter media pack around the periphery that supports the housing seal.

When employed with a perforated basket, the perforated basket can be connected and supported by the border frame.

According to a more specific embodiment, an air filter element may comprise a border frame sealingly connected to the filter media pack around the periphery with a quadrilateral flange projecting radially outward from the filter media pack. For example, the housing seal can be an axial seal along an underside of the quadrilateral flange that faces the outlet face.

According to a more specific embodiment, the air filter element may comprise a protective member extending into the filter media pack and covering the receiver, which forms a gap in the air filter element that extends toward the inlet face from the outlet face.

According to a more specific embodiment, the receiver can be in the form of a saddle with fully open ends configured for receipt of a bar completely therethrough, with the media pack projecting on opposing sides such that the filter media pack is split all the way through.

Another embodiment is directed toward an air filter element and housing assembly or an air cleaner housing for use with such an air filter element. Such an air cleaner housing includes a housing body a cover, with the air cleaner housing defining an air outlet and an air inlet. The housing body has a base and four sides extending axially from the base to an open end opposite the base, a filter element chamber and a sealing surface extending around the filter element chamber. The sealing surface can have a quadrilateral shape proximate the open end with the air filter element receivable through the open end and contained in the filter element chamber in an installed condition. The cover is removably secured to the housing body to enclose the air filter element in the filter element chamber with the housing seal in sealing engagement with the sealing surface. Further, a bar member extends from at least one of the base and four sides and projects into the receiver of the filter media pack.

According to a more specific embodiment, the air filter element is a pleat pack comprising a folded filter media sheet defining a plurality of pleat panels, with the receiver defined between a pair of adjacent pleat panels and the bar member extending into the receiver at least 5 centimeters from the outlet face.

Another embodiment is directed toward an air filter element and housing assembly. The assembly comprises an air filter element comprising a filter media pack and a housing seal, with the filter media pack defining an inlet face and an outlet face. The housing seal extends around a periphery of the filter media pack and may have a quadrilateral shape defining an outer radially outward facing perimeter of the housing seal (e.g. the outer perimeter facing radially outward and away from the media pack). The air cleaner housing includes a housing body a cover, with the air cleaner housing defining an air outlet and an air inlet. The housing body has a housing base and four housing sides extending axially from the base to an open end opposite the base. A filter element chamber and a sealing surface extend around the filter element chamber, and the sealing surface may have a quadrilateral shape proximate the open end. The air filter element is receivable through the open end and contained in the filter element chamber, with the cover removably secured to the housing body to enclose the air filter element in the filter element chamber with the housing seal in sealing engagement with the sealing surface. Further, the assembly comprises a bar extending from at least one of the housing base and housing sides. The bar projects into the outlet face of the filter media pack.

According to a more specific embodiment such as for example in an engine air cleaner, the bar projects into the filter media pack between 5 and 40 centimeters from the outlet face.

According to a more specific embodiment, the bar can a length extending between two of the sides of between 10 and 75 centimeters, and a width extending perpendicular therebetween of between 1 and 10 millimeters.

When the air filter element is a pleat pack, the air filter element can comprise a folded filter media sheet defining a plurality of pleat panels, with the bar is inserted and splits between a pair of adjacent pleat panels.

According to a more specific embodiment, a receiver formed in the outlet face of the air filter element and a protective member extends into the filter media pack and covers the receiver, with the protective member arranged to contact the bar to prevent or limit contact between the bar and the filter media pack.

According to a more specific embodiment, the bar is closer to the inlet face than the outlet face with the air filter element installed in the housing.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an illustration of an embossed deep pleated filter pack or a portion thereof (understanding that additional pleat panels can be added to extend the pack or subtracted to contract the pack) that can be used in the embodiment shown in FIG. 5, in accordance with an embodiment of the present invention;

FIG. 2 is a partly schematic plan view of a continuous sheet of filter media with adjacent creased embossed pleat panel and flat pleat panels that can be used to form the filter pack shown in FIG. 1 for use in the embodiment of FIG. 5;

FIG. 3 is a plan view and more detailed view of a portion of the filter media sheet that has not been folded up into the pack shown in FIG. 1, but is usable for the sheet schematically shown in FIG. 2 and forms the pack shown in FIG. 1 when folded into a pack;

FIG. 4 is a cross section through and side elevation illustration view of the filter media sheet shown in FIG. 3;

FIG. 4(a) is a cross section of FIG. 4 taken about the cross section line 4A-4A indicated in FIG. 4;

FIG. 5 is an exploded assembly view of an air filter element incorporating the filter media pack of FIG. 1 in combination with an air cleaner housing to form an assembly in accordance with an embodiment of the present invention;

FIG. 6 is an isometric exploded assembly view similar to that of FIG. 5 but showing various air filter element components thereof in further exploded assembly detail;

FIG. 7 is an isometric view of the air filter element employed in the embodiment of FIG. 5;

FIG. 8 is a cross section of the assembly shown in FIG. 5 in a secured condition with the filter element contained and secured between the housing cover and the housing body;

FIG. 9 is an isometric view of the air cleaner housing used in the embodiment shown in FIG. 5 in an assembled condition;

FIG. 10 is another isometric view taken from a different perspective of the air cleaner housing shown in FIG. 9;

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

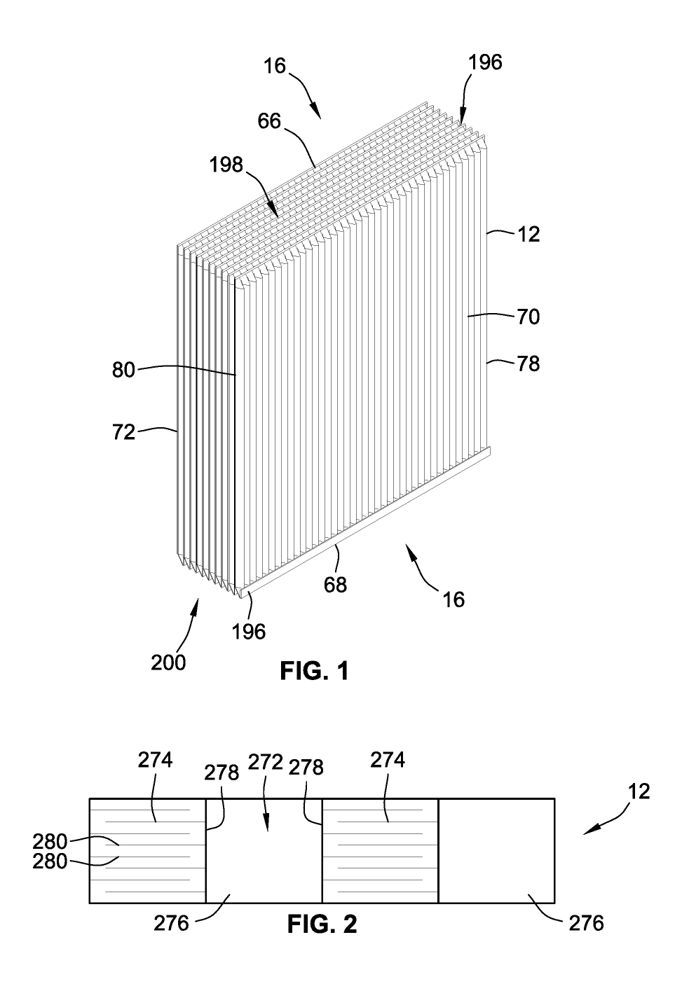

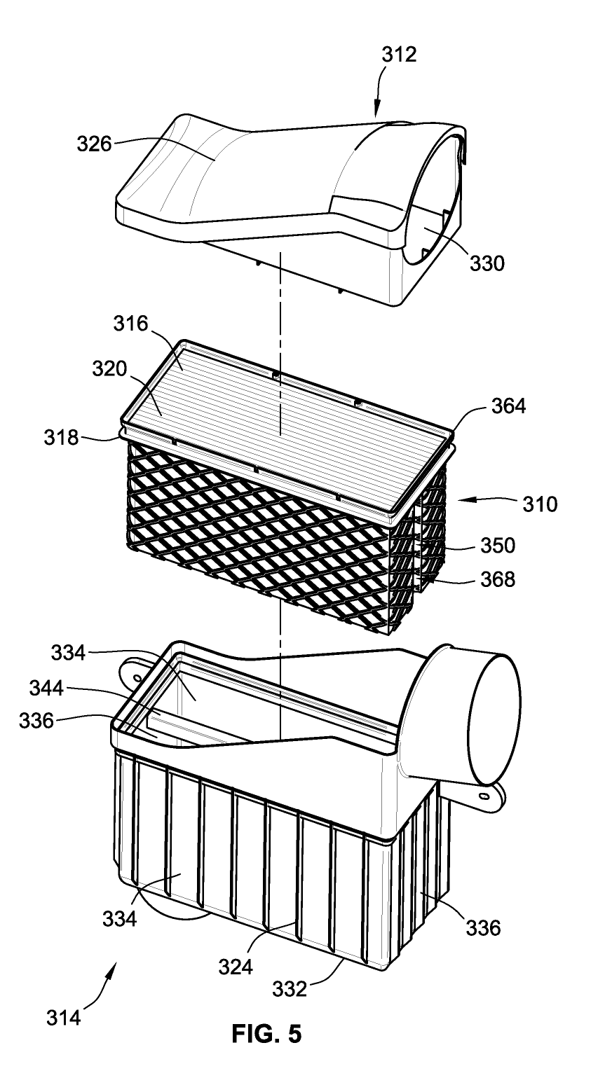

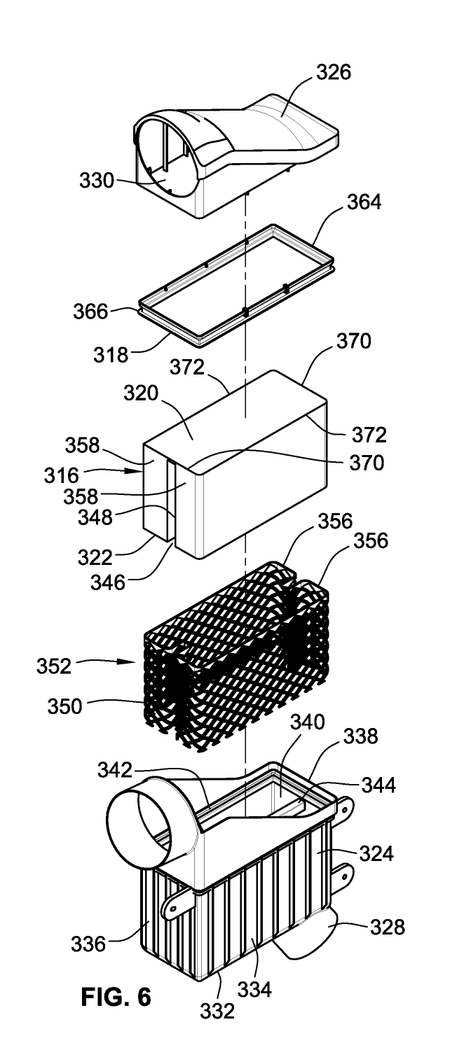

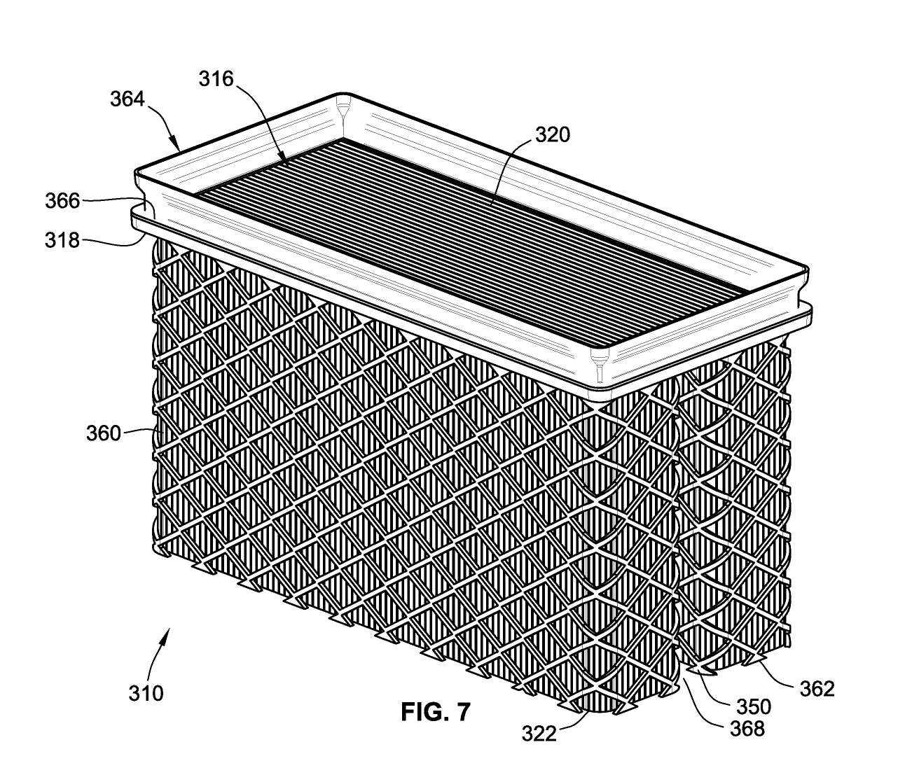

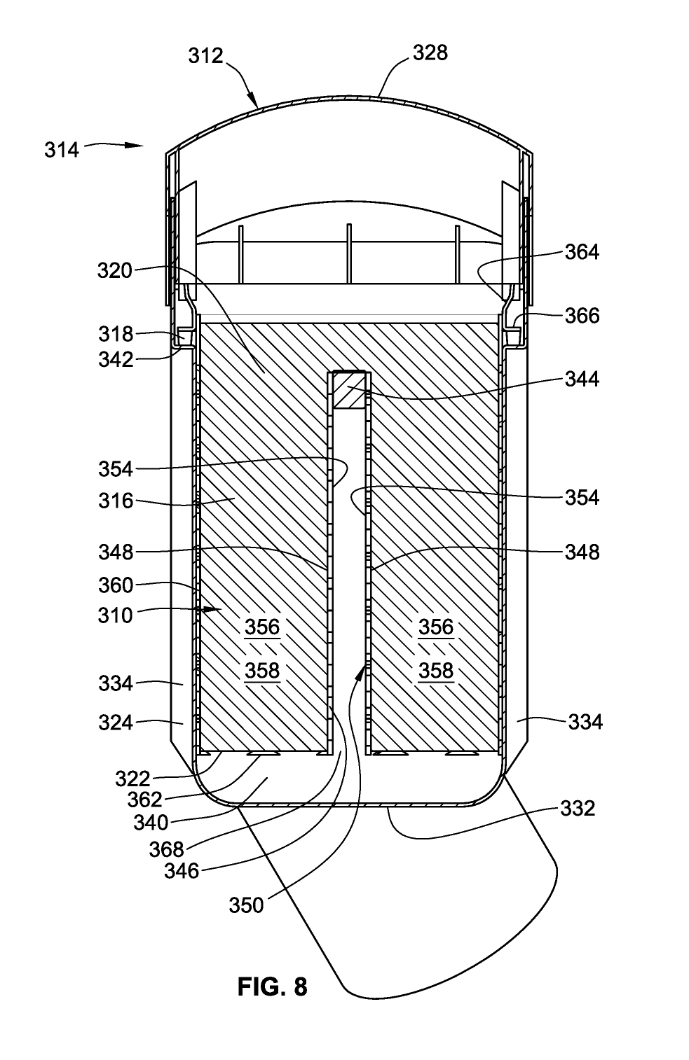

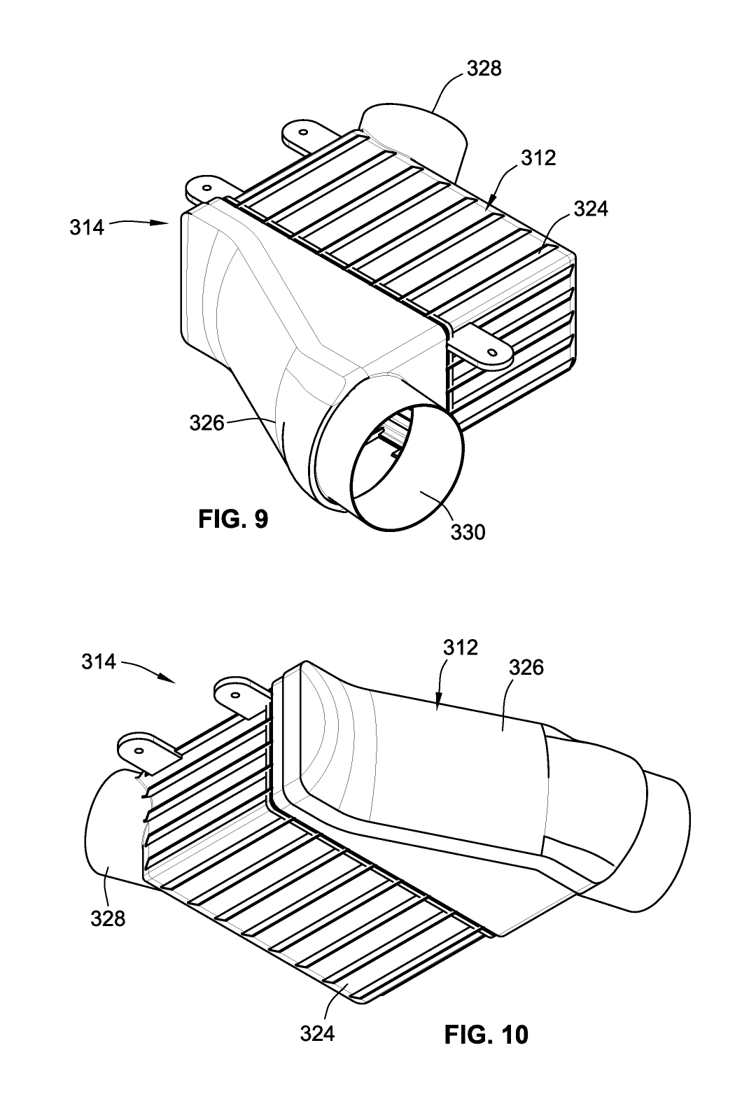

FIGS. 1-4 are directed at a filter media pack 16 such as previously disclosed in PCT/US2016/047283 that is assigned to CLARCOR Inc. and incorporated by reference herein. As will be understood, the filter media pack 16 illustrates one exemplary embodiment of a filter media pack that can be used for the pack 316 of the air filter element 310 later described shown in FIGS. 5-10. Before turning to the air filter element 310, detail will first be had to an embodiment of such a filter media pack 16 usable for the pack 316.

While various embodiments of PCT/US2016/047283 including other shapes described therein are usable herein, focus will be had on a cuboid type filter media pack, which may be compacted or configured into various shapes with shape shifting. In this regard, FIGS. 1, 2, 3, 4, and 4A of the present application corresponds with FIGS. 43, 38, 15, 16, and 16 A of PCT/US2016/047283. Therefore, to remain consistent, the numbering used for FIGS. 43, 38, 15, 16, and 16 A of PCT/US2016/047283 has also been used in FIGS. 1, 2, 3, 4, and 4 A of the present application. For additional context of examples for making or variations of the media pack 16, further reference can be had to PCT/US2016/047283, but for some context herein, parts of this publication will be substantially reproduced and discussed below.

Turning to FIG. 1, an exemplary embodiment of a filter media pack 16 is shown as a deep pleat filter media pack that can be incorporated into the filter element of the present application. The filter media pack 16 is composed of a single continuous filter media sheet 12, 272 (reference numbers 12 and 272 can be considered to reference the same sheet). The filter media pack 16 has an upstream flow face 198 and a downstream flow face 200 (also referred to herein as inlet face and outlet face). The filter media pack 16 also has an embossed pleat panel 70, 274 and a flat pleat panel 72, 276 extending between the upstream flow face 198 and the downstream flow face 200.

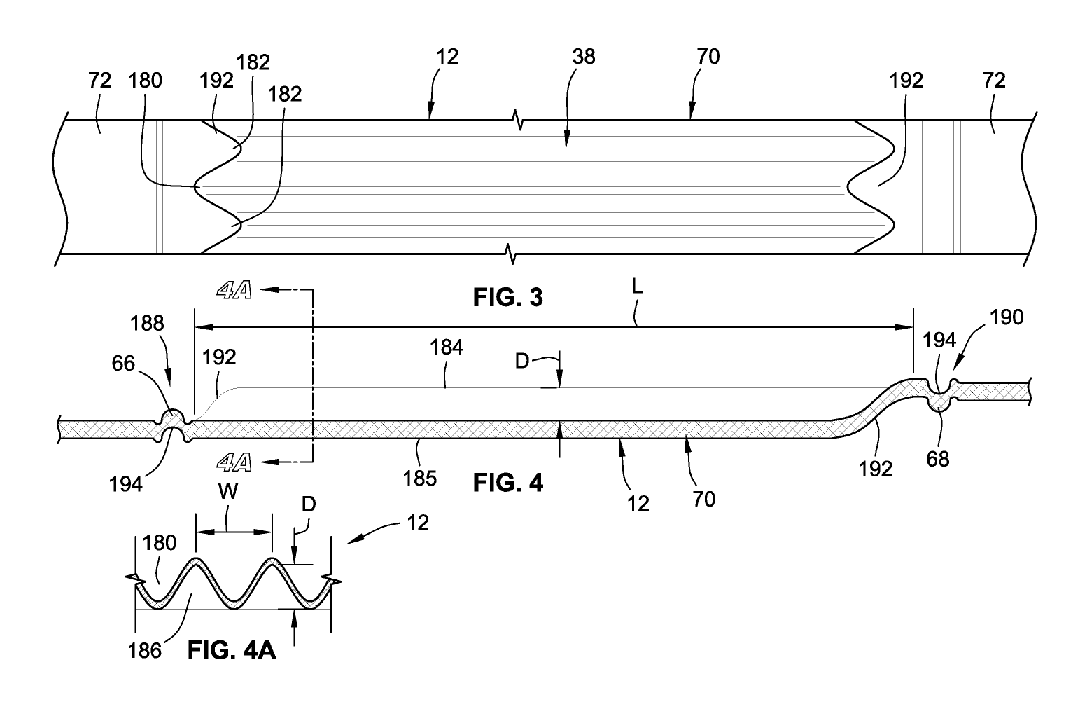

Further, the filter media sheet 12, 272 has pleat tips 196 at both flow faces 198, 200 in which one flow face is the upstream flow face and one face is the downstream flow face. The filter media sheet is creased at spaced intervals to form the pleat tips, the embossments 38 (see FIG. 3) can be seen as extending and disposed at least partially between the pleat tips 196 as shown in FIG. 1.

As shown, the intervals are uniformly spaced and with the pleat (e.g. pleat panels) extending between the pleat tips at the respective inlet and outlet faces, the distance between the pleat tips at the inlet face and the pleat tips at the outlet face may remain constant and thereby form a cuboid shape for the filter media pack 16 shown in FIG. 1.

Turning FIG. 2, illustrating is a partly schematic top view of the embossed and creased filter media sheet 12, 272 included in the filter media pack 16 of FIG. 1. The filter media sheet 12, 272 include embossed and non-embossed, unpressed or flat panels 72, 276 which are separated from one another by full creases divided by score lines 278. Embossments are provided which define grooves 280 which are schematically indicated and run perpendicular relative to the score lines 278. However, the grooves in this embodiment only extend a partial span between upstream and downstream score lines 278 of the embossed panels 70, 274. Thus, these are only partial length grooves 280 rather than full length grooves. However, the grooves overlap and a first set of the grooves 280 extend from the upstream score line to an overlap in a middle region with a second set of grooves 280 which extend from the downstream score line 278. These grooves may terminate at least 15% short of the upstream or downstream crease created by the respective score lines. As a result, an upstream set and a downstream set of grooves are laterally offset from each other, but have overlapping portions such that in any plane perpendicular to the travel direction of the media during pressing, the plane extends at least through one of the upstream and downstream sets of grooves to provide a continuous bridge strength through a middle region of the embossed sections, thus collectively the grooves and embossments extend at least 90% of the length or span between creases when two adjacent grooves or embossments are considered together. With this configuration, less of the sheet may need to be embossed and the grooves also do not need to extend fully which allows for more open flow in some embodiments.

FIGS. 3, 4, and 4A provide a partially schematic but much more detailed top view, cross-sectional side view, and cross-sectional end view of the pressed media sheet 12, 272 illustrated in FIG. 2, providing additional illustrative details to the pressed filter media sheet 12, 272. In FIG. 3 it should be noted that only a partial section of the filter media sheet is shown and break lines on the top and bottom are illustrated to show that additional embossments are placed side by side. From the foregoing description it will be readily understood how the filter media sheet 12, 272 with the embossments 38 are formed and now detail will be provided to those formed features.

The embossments 38 take the form of projecting ridges 182, when viewed from one side such as top side in the case shown in FIG. 3, and that form corresponding grooves 186 (see FIG. 4 A) also defined along the underside of the embossments 38 as well as grooves 186 that are formed between the projecting ridges 182. Additionally, on the bottom side, corresponding ridges 182 are formed with grooves 186 on the opposite side.

Typically, the embossments 38 extend a full length of the embossed pleat panel 70, 274 and between adjacent but spaced flat pleat panels 72, 276 as shown in FIGS. 3 and 4, which typically is at least 90% of the length span of the embossed pleat panels 70, 274 between upstream and downstream scores 66, 68 that provide for pivoting hinges at upstream and downstream locations indicated at 188, 190. In this manner, the upstream hinge 188 allows the upstream flat pleat panels 72, 276 illustrated in FIG. 4 to swing and overlay the bottom side of the embossed pleat panel 70, 274 shown in FIG. 4; whereas the downstream hinge 190 is oriented to allow the downstream flat pleat panel 72, 276 to overlay the top side 184 with the orientation shown in FIG. 4. It is understood that the top side 184 and bottom side 185 are reversible in that the top side may be the bottom side and the bottom side may be the top side.

In the side elevation indicated in FIG. 4, preferably the upstream hinge 188 is located at a different elevation relative to the pivoting hinge when the filter media sheet 12, 272 is viewed in side elevation. Specifically, with the filter media sheet 12, 272 or embossed panel 70, 274 lying flat, the upstream hinge is shown to be positioned below the downstream hinge 190. This allows a vertical gap to allow for folding and pleating of the filter media sheet 12, 272 to accommodate the height of the embossments 38. Preferably, the upstream and downstream hinges 188, 190 are spaced and separated from each other a vertical distance with the orientation shown in FIG. 4 preferably at least 50% of height of the embossments and more preferably at least 75% of the embossments.

Further, the ends of the embossed regions as shown in FIGS. 3 and 4 may additionally include tapered ends at the opposite ends of the embossments that lead into and merge into the hinges 188, 190. Additionally, the hinges are also provided with smaller size grooves 194 extending perpendicular to the embossments that provide for additional flexibility in the hinge structure.

Now that description has been had relative to a filter media pack 16 usable in embodiments, attention will be directed to FIGS. 5-11, illustrating an air filter element 310 that may be employed in combination with an air cleaner housing 312 to provide an element and housing assembly 314 according to an embodiment of the present invention.

As shown generally, the air filter element 310 comprising a filter media pack 316 that may simply be an extension of the pack 16 described in relation to FIGS. 1-4. The filter media pack defines an inlet face 320 and an outlet face 322 at opposing ends of the filter media pack 316. In the present embodiment those faces are planar and parallel and defined by the pleat tips at opposing ends. However, other shapes and configuration and non-parallel faces may also be employed such as shown in PCT Application Serial No. PCT/US2016/047283, filed Aug. 17, 2016 and entitled “Filter Media Packs, Methods of Making and Filter Media Presses”. Alternatively, in other embodiments, stacked fluted filter media may also be used for the filter media pack 316, such as described in US 2014/0260139 to Merritt et al., entitled “Rectangular Stacked Fluted Filter Cartridge”, or non-embossed pleated filter packs. However, the advantage of the pleated relative to fluted is that sealing at pleat tips is not required to plug flutes as in the case of traditional fluted medias, such as shown in Merritt et al.

Further, the air filter element comprises a housing seal 318 for sealing with the air cleaner housing 312. The housing seal 318 extends around a periphery of the filter media pack and has a quadrilateral shape that defines the outermost perimeter of the seal 318. Typically the seal is made from a suitable elastomeric material such as urethane, nitrile or other gasket material.

The air cleaner housing 312 includes a housing body 324 and a cover 326. These components may be molded from relatively rigid plastic material. The housing body 324 defines an air outlet 328 and the cover 326 defines an air inlet 330, which air inlet may also extend through the housing body 324 as shown. The housing body 324 has a housing base 332 and four housing sides (including opposed long sides 334 and opposed short sides 336) extending axially from the base 332 to an open end 338 opposite the base. The housing body 324 further defines a filter element chamber 338 (e.g. between open end 338 and base 332) and a sealing surface that may take the form of a quadrilateral (e.g. such as rectangular, trapezoidal, parallelogram, rhombus) seal seat surface 342 extending around the filter element chamber 338. The seal seat surface 342 has a quadrilateral shape proximate the open end 338 that surrounds the filter element chamber 338.

The air filter element 310 is receivable through the open end 338 and is contained in the filter element chamber 340 in the installed condition. The cover 326 is removably secured to the housing body 324 (e.g. with thumb screws, other fasteners or latches) to enclose the air filter element 310 in the filter element chamber 340 with the housing seal 318 in sealing engagement with the seal seat surface 342.

In this embodiment the sealing engagement between housing seal 318 and seat surface 342 forms an axial seal through axial compression.

A bar 344 extends from at least one of the housing base 332 and housing sides 334, 336 and projects into the outlet face 322 of the filter media pack 316.

For purposes of illustration, the bar 344 is not shown to scale relative to the remainder of the housing and is enlarged for better illustration, but it may be a relatively thin bar that is received within a corresponding saddle shaped receiver 246 (that shows a gap that is also exaggerated for illustrative purposes) formed in the outlet face 322 of the filter media pack 316.

The filter illustrated in FIGS. 5-10 herein is particularly adapted for specific engine air filtration applications and preferred dimensions recited herein are applicable to that particular application.

Preferably, the bar 344 projects into the filter media pack between 5 and 40 centimeters from the outlet face 322, and preferably between 15 and 35 centimeters. For example, in the installed condition, the bar 344 is closer to the inlet face 320 than the outlet face 322.

The bar 344 may serve one or more functions. For example, in the case of a pleated filter, the bar 344 may serve to compact the media by splitting the pleats into segments (and thereby extending parallel to pleat tips). The bar 344 may contact and support the filter media pack to help prevent collapse or maintain shape to ensure more regular fluid flow through the pack. Pleat packs traditionally have less support (e.g. as compared with stacked fluted filter elements as in US 2014/0260139, so the bar can assist in that regard. Less support on the filter element may need to be incorporated in some embodiments due to the bar. The bar 344 may also be used to ensure correct installation and orientation relative to the seal. While one bar is shown, it may be that different engine applications desire different filter performance and as such different bar positions, or multiple bars may be used although only one bar 344 is shown in the illustrated embodiment, thus serving a key function. Any of these or other uses of the bar may be employed.

In most typical envisioned engine applications, the bar 344 has a length extending between two of the sides of between 10 and 75 centimeters, and a width extending perpendicular therebetween of between 1 and 10 millimeters (recalling that width of the bar 344 and the saddle shaped receiver 346 have been exaggerated in the illustrations for better viewing).

Unlike the housing seal 318 that is elastomeric, the bar 344 is a rigid member, preferably metal separately attached to the housing body, or alternatively an integrally molded plastic member formed with the housing body 324, or separately affixed thereto. The bar 344 is shown to extending and be supported at ends by opposed housing short sides 336 and spaced and not supported by the base 332.

As noted, preferably, the air filter element 310 comprises a pleat pack (e.g. pack 316) comprising a folded filter media sheet defining a plurality of pleat panels as discussed above, and the bar 344 is inserted and splits between a pair of adjacent pleat panels. Inner opposed pleat panels 348 are indicated in the Figures.

For many most typical engine air applications, the filter media pack 316 comprises: a width across the inlet face of between 5 and 75 centimeters (more typically between 15 and 50 centimeters for most applications); a length across the inlet face that is perpendicular to the width of between 10 and 75 centimeters (more typically between 20 and 60 centimeters for most applications); and a depth perpendicular to the width and the length, the depth being between 10 and 40 centimeters (more typically between 15 and 30 centimeters for most applications).

In most filter elements whether a pleated or fluted, the filter media pack comprises a filter media sheet that is gathered to provide a plurality of layers, including a spacing of at least 2 layers of the filter media sheet per centimeter as measured across the inlet face and the outlet face, wherein the receiver comprises a gap at the outlet face between adjacent members of the layers defining opposite sides of the gap that is larger than the spacing to accommodate the bar.

In furtherance to the saddle shaped receiver 346 formed in the outlet face, a protective member 350 can extend into the filter media pack 316 and can cover the receiver 346. The protective member 350 can be arranged to contact the bar 344 to prevent or limit contact between the bar 344 and the filter media pack 316.

Preferably, the protective member 350 is preformed and may look like mesh or netting that allows also for open air flow while providing protection. It may also comprise plastic material like border frame 364.

For example or for positioning, the protective member 350 can be part of the perforated basket member 352. The perforated basket member 352 surrounds a periphery of the filter media pack 316 and covers the outlet face.

The protective member 350 may have protective panels 354 forming a V-shape (herein V-shape includes U-shape), that in conjunction with the remainder of the basket 352 forms at least two pockets 356 for receipt of at least two sections 358 of the media pack 316.

For example, the perforated basket 352 can including a peripheral wall 360, an outlet wall 362 (including separate portions for each pocket 356) and a divider portion provided by the protective panels 354, that can divide and split up pleat pack that otherwise has pleats that can be formed by a single continuous folded sheet of filter media in an embodiment (separate packs alternatively can be installed into different pockets in another embodiment). The peripheral wall 360 surrounds and protects the filter media pack 316 around the periphery. The outlet wall 362 covers and protects the filter media pack over the outlet face 322. The divider portion extends into the outlet face 322 and defining first and second portions (e.g. protective panels 354) on opposing sides of the filter media pack receiver 346 and are interposed between the receiver 346 and the bar 344.

The protective member 350 thus extends into the filter media pack and covering the receiver 346, forming a V-shaped gap 360 that in the air filter element that extends toward the inlet face from the outlet face. The gap 360 is a completely open gap extending completely through the filter element between opposed ends to accommodate the bar that extends entirely through opposed ends of the filter element. The V-shaped gap 360 extends through the peripheral wall 360 of the basket.

Preferably, the entire basket is perforated throughout the protective panels 354, the peripheral wall 360 and the outlet wall 362, and may look like mesh or netting that can be preferably formed as one interconnected and most preferably unitary molded part of plastic material as illustrated.

Further, the air filter element 310 can comprise a border frame 364 sealingly connected to the filter media pack 316 around the periphery. The border frame 364 supports the housing seal 316. Preferably, the perforated basket 352 is connected and supported by the border frame 364. For example, the perforated basket 352 can be molded unitary with the border frame 364 as one single component part, also of plastic material. Alternatively, as shown, the two can be formed separate and then secured together with adhesive welded or otherwise connected sufficient to form a protective barrier to the filter media pack. When formed separate, an uninterrupted solid upper wall quadrilateral rim may be provided at the upper free end of the basket to facilitate connection.

The border frame 364 can be sealingly connected to the filter media pack around the periphery to prevent unfiltered air flow past the filter element such as by a continuous sealing adhesive (e.g. urethane or other adhesive) applied around the rectangular interface between the frame and the pack. The border frame 364 has a quadrilateral flange 366 projecting radially outward from the filter media pack 316 for supporting the housing seal 318. In this embodiment, the housing seal 318 is an axial seal along an underside of the quadrilateral flange 366 and faces toward the outlet face 322.

The air filter element 310 and its filter media pack 316 has a quadrilateral shape with a pair of short sides 370 and a pair of long sides 372 that are complimentary to the sides 334, 336 of the housing, with the long sides being longer than the short sides. Preferably, the receiver 346 extends longitudinally transversely between the short sides 370 as shown.

In an embodiment and for simplicity in manufacture, the air filter element is provided only with a single continuous uninterrupted filter media sheet extending over and bridging across the gap 368. Multiple sheets are therefore not needed and can prevent the need to seal between sheets, thereby avoiding a potential leakpath.

When in the form of a pleat pack as shown, the filter media pack 316 includes a filter media sheet that includes a plurality of folds that form a plurality of pleats with pleat panels extending between inlet pleat tips along the inlet face and outlet pleat tips along the outlet face such as discussed in greater detail in relation to FIGS. 1-4, with the pleat tips and the pleat panels extending between opposed side edges of the pleated filter media pack. Typically, at least 3 pleat panels per centimeter across inlet face and the outlet face are provided.

For example, the filter pleats can include a pleat spacing of at least 0.75 pleats per centimeter with 1.5 pleat panels per centimeter as measured across the inlet face and the outlet face. The receiver 346 forms and therefore comprises the gap 368 at the outlet face between adjacent members of the inner pleat panels 348 that spaces these pleat panels 348 more than the pleat spacing.

Also by employing a single continuous uninterrupted sheet extending over and bridging across the gap 368, and the gap 368 can comprises a split wedge formed the pleat pack between the adjacent members of the inner pleat panels 348 defining opposite sides of the gap 368.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An air filter element, comprising:
a filter media pack defining an inlet face and an outlet face, the filter media pack including filter media extending between the inlet face and the outlet face;
a housing seal extending around a periphery of the filter media pack to form a quadrilateral shape, the housing seal being positioned proximate the inlet face and distal from the outlet face; and
a receiver defined into the filter media pack and extending into the outlet face.

2. The air filter element of claim 1, wherein the filter media pack has a quadrilateral shape with a pair of short sides and a pair of long sides, the long sides being longer than the short sides, the receiver extending longitudinally transversely between the short sides.

3. The air filter element of claim 1, wherein the filter media pack comprises:
a width across the inlet face of between 5 and 75 centimeters;
a length across the inlet face that is perpendicular to the width of between 10 and 75 centimeters;
a depth perpendicular to the width and the length, the depth being between 10 and 40 centimeters.

4. The air filter element of claim 1, wherein the filter media pack comprises a filter media sheet that is gathered to provide a plurality of layers, including a spacing of at least 2 layers of the filter media sheet per centimeter as measured across the inlet face and the outlet face, wherein the receiver comprises a gap at the outlet face between adjacent members of the layers defining opposite sides of the gap that is larger than the spacing.

5. The filter element of claim 4, wherein the filter media sheet comprises a single continuous uninterrupted sheet extending over and bridging across the gap.

6. The air filter element of claim 1, wherein the filter media pack comprises a pleat pack including a filter media sheet that includes a plurality of folds that form a plurality of pleats with pleat panels extending between inlet pleat tips along the inlet face and outlet pleat tips along the outlet face, the pleat tips and the pleat panels extending between opposed side edges of the pleated filter media pack, wherein at least 3 pleat panels per centimeter across inlet face and the outlet face are provided.

7. The air filter element of claim 6, wherein the pleats includes a pleat spacing of at least 0.75 pleats per centimeter with 1.5 pleat panels per centimeter as measured across the inlet face and the outlet face, wherein the receiver comprises a gap at the outlet face between adjacent members of the pleat panels that spaces the pleat panels more than the pleat spacing.

8. The air filter element of claim 7, wherein the filter media sheet comprises a single continuous uninterrupted sheet extending over and bridging across the gap, and wherein the gap comprises a split wedge formed the pleat pack between the adjacent members of the pleat panels defining opposite sides of the gap.

9. The air filter element of claim 1, further comprising a perforated basket including a peripheral wall, an outlet wall and a divider portion, the peripheral wall protecting the filter media pack around the periphery, outlet wall covering and protecting the filter media pack over the outlet face, the divider portion extending into the outlet face and defining first and second portions on opposing sides of the receiver and providing a protective barrier along the receiver facing the outlet face.

10. The air filter element of claim 10, further comprising a border frame sealingly connected to the filter media pack around the periphery, the border frame supporting the housing seal, the perforated basket being connected and supported by the border frame.

11. The air filter element of claim 1, further comprising a border frame sealingly connected to the filter media pack around the periphery, the border frame having a quadrilateral flange projecting radially outward from the filter media pack, the housing seal being an axial seal along an underside of the quadrilateral flange that faces the outlet face.

12. The air filter element of claim 1, further a protective member extending into the filter media pack and covering the receiver, forming a gap in the air filter element that extends toward the inlet face from the outlet face.

13. The air filter element of claim 1, wherein the receiver is in the form of a saddle with fully open ends configured for receipt of a bar completely therethrough, the media pack projecting on opposing sides such that the filter media pack is split all the way through.

14. An air filter element and housing assembly, comprising the air filter element of claim 1, and further comprising:
an air cleaner housing including a housing body a cover, the air cleaner housing defining an air outlet and an air inlet, the housing body having a base and four sides extending axially from the base to an open end opposite the base, a filter element chamber and a sealing surface extending around the filter element chamber, the sealing surface having a quadrilateral shape proximate the open end, the air filter element receivable through the open end and contained in the filter element chamber, the cover removably secured to the housing body to enclose the air filter element in the filter element chamber with the housing seal in sealing engagement with the sealing surface; and
a bar member extending from at least one of the base and four sides and projecting into the receiver of the filter media pack.

15. The assembly of claim 14, wherein the air filter element is a pleat pack comprising a folded filter media sheet defining a plurality of pleat panels, and wherein the receiver is defined between a pair of adjacent pleat panels and the bar member extends into the receiver at least 5 centimeters from the outlet face.

16. An air filter element and housing assembly, comprising:
an air filter element comprising a filter media pack and a housing seal, the filter media pack defining an inlet face and an outlet face; the housing seal extending around a periphery of the filter media pack and having a quadrilateral shape;
an air cleaner housing including a housing body a cover, the air cleaner housing defining an air outlet and an air inlet, the housing body having a housing base and four housing sides extending axially from the base to an open end opposite the base, a filter element chamber and a sealing surface extending around the filter element chamber, the sealing surface having a quadrilateral shape proximate the open end, the air filter element receivable through the open end and contained in the filter element chamber, the cover removably secured to the housing body to enclose the air filter element in the filter element chamber with the housing seal in sealing engagement with the sealing surface; and
a bar extending from at least one of the housing base and housing sides and projecting into the outlet face of the filter media pack.

17. The assembly of claim 16, wherein the bar projects into the filter media pack between 5 and 40 centimeters from the outlet face.

18. The assembly of claim 16, wherein the bar has a length extending between two of the sides of between 10 and 75 centimeters, and a width extending perpendicular therebetween of between 1 and 10 millimeters.

19. The assembly of claim 16, wherein the air filter element is a pleat pack comprising a folded filter media sheet defining a plurality of pleat panels, and the bar is inserted and splits between a pair of adjacent pleat panels.

20. The air assembly of claim 16, wherein the filter media pack comprises:
a width across the inlet face of between 5 and 75 centimeters;
a length across the inlet face that is perpendicular to the width of between 10 and 75 centimeters;
a depth perpendicular to the width and the length, the depth being between 10 and 40 centimeters; and
wherein the filter media pack comprises a filter media sheet that is gathered to provide a plurality of layers, including a spacing of at least 2 layers of the filter media sheet per centimeter as measured across the inlet face and the outlet face, wherein the receiver comprises a gap at the outlet face between adjacent members of the layers defining opposite sides of the gap that is larger than the spacing to accommodate the bar.

21. The assembly of claim 16, further comprising a receiver formed in the outlet face and a protective member extending into the filter media pack and covering the receiver, the protective member arranged to contact the bar to prevent or limit contact between the bar and the filter media pack.

22. The assembly of claim 21, further comprising a perforated basket member surrounding a periphery of the filter media pack and covering the outlet face, the protective member being part of the perforated basket member.

23. The assembly of claim 22, further comprising a border frame sealingly connected to the filter media pack around the periphery, the border frame supporting the housing seal, the perforated basket being connected and supported by the border frame.

24. The assembly of claim 16, wherein the bar is closer to the inlet face than the outlet face.
